(19) United States
(12) Patent Application Publication
(10) Pub. No.: US 2026/0162331 A1
(43) Pub. Date: Jun. 11, 2026

(54) TEXT-BASED PICTURE GENERATION METHOD, MODEL TRAINING METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventor: Xiaoshuai CHEN, Shenzhen (CN)

(21) Appl. No.: 19/179,437

(22) Filed: Apr. 15, 2025

Related U.S. Application Data
(63) Continuation of application No. PCT/CN2024/070118, filed on Jan. 2, 2024.

(30) Foreign Application Priority Data
Mar. 3, 2023 (CN) 202310240545.9

(51) Int. Cl. G06T 11/60; G06F 40/166; G06F 40/30

(52) U.S. Cl. CPC G06T 11/60; G06F 40/166; G06F 40/30

(57) ABSTRACT

A text-based picture generation method includes: a terminal obtains first picture description text describing picture content of a picture to be generated; performs text expansion on the first picture description text by using a picture description text expansion model, to obtain a second picture description text; and generates a picture based on the second picture description text. The picture description text expansion model is trained based on sample standard picture description texts and sample brief picture description texts of reference pictures and configured to expand a brief picture description text into a standard picture description text, the standard picture description text including a plurality of words describing a primary description object of a target picture and at least one word describing a secondary description object of the target picture, and the brief picture description text being a keyword describing the primary description object in the standard picture description text.

### CROSS-REFERENCES TO RELATED APPLICATIONS

This application is a continuation of PCT Application No. PCT/CN2024/070118, filed on Jan. 2, 2024, which claims priority to Chinese Patent Application No. 2023102405459 filed on Mar. 3, 2023 and entitled “TEXT-BASED PICTURE GENERATION METHOD AND APPARATUS, DEVICE, AND STORAGE MEDIUM”, the entire contents of all of which are incorporated herein by reference.

### FIELD OF THE TECHNOLOGY

Embodiments of the present disclosure relate to the field of computer technologies, and in particular, to a text-based picture generation method and apparatus, a device, and a storage medium.

### BACKGROUND OF THE DISCLOSURE

When posting comments, community posts, and the like, users sometimes would like to create pictures meeting their requirements of personalized expression. With continuous development of computer technologies, text-based picture generation technologies emerge gradually. A user may instruct a device to generate a picture only by inputting picture description text.

When generating a picture with a relatively high quality, professional and complex picture description text are needed. For example, to generate a relatively high-quality picture of mountain peaks, the following example of picture description text can be inputted: mountain, majestic, awe-inspiring, snow-capped, quiet, great in size, soaring peak, cloud and mist, stretching, hilly, lush and green, valley, thrilling, horizon line, and scenery.

For a non-expert user, it is quite difficult to input the foregoing professional and complex picture description text. The user usually can only input one basic concept such as “mountain” and “sea”. Because the picture description text inputted by the user is excessively simple, the quality of a generated picture is relatively low.

### SUMMARY

Embodiments of the present disclosure provide a text-based picture generation method and apparatus, a device, and a storage medium, and a training method and apparatus for a picture description text expansion model, a device, and a storage medium.

According to an aspect, a text-based picture generation method is provided. The method includes: obtaining first picture description text, the first picture description text describing picture content of a picture to be generated; performing text expansion on the first picture description text by using a picture description text expansion model, to obtain a second picture description text, the picture description text expansion model being trained based on sample standard picture description texts and sample brief picture description texts of reference pictures and configured to expand a brief picture description text into a standard picture description text, the standard picture description text including a plurality of words that describe a primary description object of a target picture and at least one word that describes a secondary description object of the target picture, and the brief picture description text being a keyword describing the primary description object in the standard picture description text; and generating a picture based on the second picture description text.

According to another aspect, a training method for a picture description text expansion model used in picture generation is provided. The method includes: obtaining description of a picture in a network as sample standard picture description text; performing keyword extraction on the standard picture description text, and using an extracted keyword as brief picture description text; and training a picture description text expansion model based on the standard picture description text and the brief picture description text, the picture description text expansion model being configured to expand the picture description text configured for generating a picture.

According to another aspect, a text-based picture generation apparatus is provided. The apparatus includes: an obtaining module, configured to obtain first picture description text, the first picture description text describing picture content of a picture to be generated; an expansion module, configured to perform text expansion on the first picture description text by using a picture description text expansion model to obtain a second picture description text, the picture description text expansion model being trained based on sample standard picture description texts and sample brief picture description texts of reference pictures and configured to expand a brief picture description text into a standard picture description text, the standard picture description text including a plurality of words that describe a primary description object of a target picture and at least one word that describes a secondary description object of the target picture, and the brief picture description text being a keyword describing the primary description object in the standard picture description text; and a generation module, configured to generate a picture based on the second picture description text.

According to another aspect, a training apparatus for a picture description text expansion model used in picture generation is provided. The apparatus includes: an obtaining module, configured to obtain description of a picture in a network as standard picture description text; an extraction module, configured to perform keyword extraction on the standard picture description text, and use an extracted keyword as brief picture description text; and a training module, configured to train a picture description text expansion model based on the standard picture description text and the brief picture description text, the picture description text expansion model being configured to expand the picture description text configured for generating a picture.

According to another aspect, a computer device is provided, including a processor and a memory, the memory having at least one computer-readable instruction stored therein, the at least one computer-readable instruction being loaded and executed by the processor, to implement the methods described in the above aspects.

According to another aspect, a non-transitory computer-readable storage medium is provided, the computer-readable storage medium having at least one computer-readable instruction stored therein, and the at least one computer-readable instruction being loaded and executed by a processor to implement the methods described in the above aspects.

Details of one or more embodiments of the present disclosure are provided in the accompanying drawings and descriptions below. Other features and advantages of the present disclosure become clear with reference to the specification, the accompanying drawings, and the claims.

### BRIEF DESCRIPTION OF THE DRAWINGS

FIG. 1 is a schematic diagram of an implementation environment according to an embodiment of the present disclosure.

FIG. 2 is a flowchart of a text-based picture generation method according to an embodiment of the present disclosure.

FIG. 3 is a flowchart of a text-based picture generation method according to an embodiment of the present disclosure.

FIG. 4 is a schematic diagram of a picture description text expansion model according to an embodiment of the present disclosure.

FIG. 5 is a schematic diagram of a picture generation model according to an embodiment of the present disclosure.

FIG. 6 is a schematic diagram of a correlation model according to an embodiment of the present disclosure.

FIG. 7 is a schematic diagram of a quality evaluation model according to an embodiment of the present disclosure.

FIG. 8 is a flowchart of a text-based picture generation method according to an embodiment of the present disclosure.

FIG. 9 is a flowchart of a training method for a picture description text expansion model used in picture generation according to an embodiment of the present disclosure.

FIG. 10 is a schematic structural diagram of a text-based picture generation apparatus according to an embodiment of the present disclosure.

FIG. 11 is a schematic structural diagram of another text-based picture generation apparatus according to an embodiment of the present disclosure.

FIG. 12 is a schematic structural diagram of a training apparatus for a picture description text expansion model used in picture generation according to an embodiment of the present disclosure.

FIG. 13 is a schematic structural diagram of a terminal according to an embodiment of the present disclosure.

FIG. 14 is a schematic structural diagram of a server according to an embodiment of the present disclosure.

### DESCRIPTION OF EMBODIMENTS

Technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

Terms “first”, “second”, and the like used in the present disclosure may be configured for describing various concepts in this specification. However, these concepts are not limited by the terms unless otherwise specified. The terms are merely configured for distinguishing one concept from another concept. For example, without departing from the scope of the present disclosure, a first picture may be referred to as a second picture, and similarly, the second picture may be referred to as the first picture.

“At least one” means one or more. For example, at least one picture may be pictures whose quantity is any integer greater than or equal to one, such as one picture, two pictures, or three pictures. “A plurality of” means two or more. For example, a plurality of pictures may be pictures whose quantity is any integer greater than or equal to two, such as two pictures or three pictures. “Each” means each of at least one. For example, each picture refers to each of a plurality of pictures. If the plurality of pictures are three pictures, each picture refers to each of the three pictures.

In specific implementations of the present disclosure, relevant data such as user information is involved. In a case that the foregoing embodiments of the present disclosure are applied to a specific product or technology, a permission or consent of a user is required, and collection, use, and processing of the relevant data need to comply with relevant laws, regulations, and standards of relevant countries and regions.

A text-based picture generation method provided in embodiments of the present disclosure may be applied to any scenario in which a picture needs to be generated.

For example, the method is applied to an information posting scenario: When posting comments and community posts, users usually need to create pictures meeting their requirements of personalized expression. If the text-based picture generation method provided in the embodiments of the present disclosure is used, the users can generate a picture with rich content only by inputting brief picture description text, or even only by inputting a word, and thus the quality of the generated picture is improved.

For another example, the method is applied to a painting creation scenario: Because the text-based picture generation has randomness and diversity, if the text-based picture generation method provided in the embodiments of the present disclosure is used, the users can randomly generate a picture with corresponding content only by inputting the brief picture description text, or even by only inputting one word, and the users may find creation inspiration for creation from the randomly generated picture.

In addition, in the embodiments of the present disclosure, only an information posting scenario and a painting creation scenario are used as examples to describe a scenario in which a picture needs to be generated, and the scenario in which the picture needs to be generated is not limited. In some other embodiments, the scenario in which the picture needs to be generated may alternatively be a work aid scenario or the like. The work aid scenario is a scenario in which when an operation of generating a picture needs to be performed, text is inputted by an interaction interface implemented through a computer program, and a picture generated based on the text is outputted.

The text-based picture generation method provided in the embodiments of the present disclosure is performed by a terminal. In some embodiments, the terminal is a smartphone, a tablet computer, a notebook computer, a desktop computer, a smart speaker, a smart television, a smart watch, a hand-held portable game device, or the like, but is not limited thereto.

A training method for a picture description text expansion model used in picture generation provided in embodiments of the present disclosure is performed by a computer device. In some embodiments, the computer device is a terminal. The terminal may be a smartphone, a tablet computer, a notebook computer, a desktop computer, a smart speaker, a smart television, a smart watch, a hand-held portable game device, or the like, but is not limited thereto. In some embodiments, the computer device is a server. The server may be an independent physical server, a server cluster composed of a plurality of physical servers or a distributed system, or a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence (AI) platform.

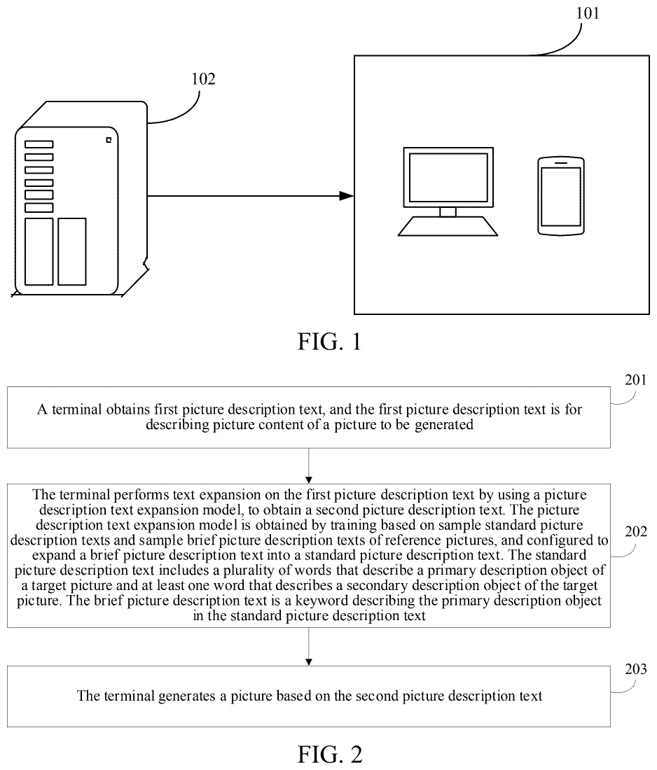

FIG. 1 is a schematic diagram of an implementation environment according to an embodiment of the present disclosure. As shown in FIG. 1, the implementation environment includes a terminal 101 and a server 102. The terminal 101 and the server 102 are directly or indirectly connected in a wired or wireless communication manner. FIG. 1 only shows an example in which the server 102 is connected to the terminal 101. In addition, the server 102 may be connected to another terminal.

In some embodiments, a target application whose service is provided by the server 102 is installed on the terminal 101, and the terminal 101 can implement functions such as data transmission and message interaction by using the target application. In some embodiments, the target application is in an operating system of the terminal 101, or provided by a third party. For example, the target application is a picture generation application. The picture generation application has a picture generation function. Certainly, the picture generation application can also have another function such as a sharing function and a comment function.

In some embodiments, the terminal 101 obtains picture description text inputted by a user, and transmits the picture description text to the server 102. The server 102 generates a picture based on the picture description text, and transmits the picture to the terminal 101. The terminal 101 receives and shows the picture. In some other embodiments, the terminal 101 obtains picture description text inputted by a user, and automatically generates a picture based on the picture description text. The server 102 is configured to update a procedure in which the terminal 101 generates the picture based on the picture description text.

FIG. 2 is a flowchart of a text-based picture generation method according to an embodiment of the present disclosure. In this embodiment of the present disclosure, using a terminal as an execution body is taken as an example for exemplary description. Referring to FIG. 2, the method includes:

201: A terminal obtains first picture description text. The first picture description text describes picture content of a picture to be generated.

The picture description text describes the picture content in a text form. The picture description text may include words in any language, and may further include punctuations. For example, the picture description text includes Chinese characters “SHAN (mountain)”, “XIAOHE (river)”, “DAHAI (sea)”, and the like. For another example, the picture description text may include English words “mountain”, “girl”, and the like. In this embodiment of the present disclosure, the terminal may generate the picture based on the picture description text. The first picture description text is configured for generating the picture.

In some embodiments, the first picture description text is inputted by a user. In some embodiments, the terminal displays a picture generation interface. The picture generation interface is configured to generate a picture based on text. The picture generation interface displays a picture description text input box, and obtains the picture description text inputted in the picture description text input box, to obtain first picture description text. In some other embodiments, the first picture description text is transmitted by another device to the terminal, or the first picture description text is searched by the terminal from a network. A manner of obtaining the first picture description text is not limited in this embodiment of the present disclosure.

202: The terminal performs text expansion on the first picture description text by using a picture description text expansion model, to obtain a second picture description text. The picture description text expansion model is obtained by training based on sample standard picture description texts and sample brief picture description texts of reference pictures, and configured to expand a brief picture description text into a standard picture description text. The standard picture description text includes a plurality of words that describe a primary description object of a target picture and at least one word that describes a secondary description object of the target picture. The brief picture description text is a keyword describing the primary description object in the standard picture description text.

Because the first picture description text is configured for describing the picture content of the to-be-generated picture, a simpler first picture description text results in less detailed picture content of the picture generated based on the first picture description text, less appealing backgrounds, and lower picture quality. In contrast, a more detailed first picture description text leads to more comprehensive picture content of the picture generated based on the first picture description text, more visually appealing backgrounds, and higher picture quality. To generate the relatively high-quality picture based on the picture description text, in this embodiment of the present disclosure, after the first picture description text is obtained, text expansion is performed on the first picture description text by using the picture description text expansion model, to obtain the second picture description text with rich content, and a picture is generated based on the second picture description text. The picture description text expansion model may be any natural language generation model. The picture description text expansion model is not limited in this embodiment of the present disclosure.

Because the picture description text expansion model is obtained by training based on the standard picture description text and the brief picture description text of each reference picture, the standard picture description text includes a plurality of words that describe a primary description object of a target picture and at least one word that describes a secondary description object of the target picture, and the brief picture description text is a keyword for describing the primary description object in the standard picture description text, the picture description text expansion model may expand the keyword describing the primary description object into other words describing the primary description objects, and may further expand the keyword into words describing the secondary description object, thereby enriching the content of the expanded picture description text. In other words, the user only needs to input one word, and the picture description text expansion model may expand the picture description text with rich content.

For example, the first picture description text inputted by the user is “mountain”. The picture description text expansion model can expand “mountain” into other words describing the mountain, such as words “valley”, “mountain range”, “canyon”, “perilous peak”, and “hilly”. Moreover, because snow and mountain, and cloud, mist, and mountain usually appear in a same picture, the picture description text expansion model can further expand “mountain” into words describing other secondary description objects, such as “snow-capped”, and “cloud and mist”.

203: The terminal generates a picture based on the second picture description text.

For example, if the first picture description text inputted by the user is “little girl”, the terminal may generate a picture of a little girl based on the first picture description text. However, because the first picture description text only includes “little girl”, and there is no indication for a background, the background of the little girl in the picture is blurred, and the quality of the generated picture is poor. By performing text expansion on the first picture description text in operation 202, the second picture description text such as “little girl, cute, long hair, round face, flower, and run” may be obtained. A picture in which a little girl is running in a garden may be generated based on the second picture description text. In this picture, background information is added, the content is rich, and the quality of the generated picture is high.

This embodiment of the present disclosure provides a text-based picture generation solution. First, text expansion is performed on the first picture description text by using the picture description text expansion model, to obtain the second picture description text, and then the picture is generated by using the second picture description text. Because the picture description text expansion model is obtained by training based on the standard picture description text and the brief picture description text of each reference picture, the standard picture description text includes a plurality of words describing a primary description object of the reference picture and at least one word that describes a secondary description object of the target picture, and the brief picture description text is a keyword for describing the primary description object in the standard picture description text; the picture description text expansion model may expand the keyword describing the primary description object into other words describing the primary description object, and may further expand the keyword into words describing the secondary description object. Therefore, the content of the expanded picture description text is rich, the content of the picture generated based on the expanded picture description text is rich, and accordingly the picture generation quality is improved.

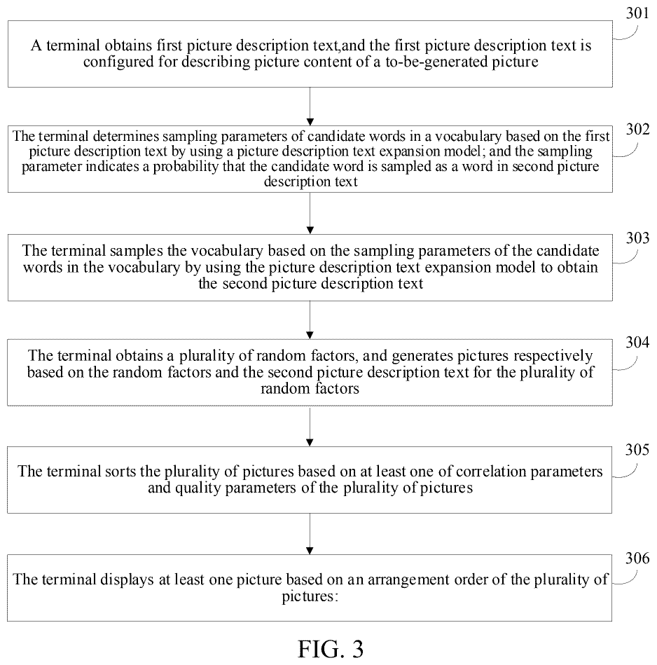

FIG. 3 is a flowchart of a text-based picture generation method according to an embodiment of the present disclosure. In this embodiment of the present disclosure, using a terminal as an execution body is taken as an example for exemplary description. Referring to FIG. 3, the method includes:

301: A terminal obtains first picture description text. The first picture description text is configured for describing picture content of a to-be-generated picture.

Operation 301 is similar to the foregoing operation 201. Details are not described herein again.

302: The terminal determines sampling parameters of words (also referred as candidate words) in a vocabulary based on the first picture description text by using a picture description text expansion model. The sampling parameter indicates a probability that a corresponding candidate word is sampled as a word in second picture description text.

The vocabulary includes a plurality of words, and the plurality of words in the vocabulary are determined according to experience or an implementation scenario. Specific content of the vocabulary is not limited in this embodiment of the present disclosure.

In this embodiment of the present disclosure, the vocabulary is sampled by using the picture description text expansion model based on the first picture description text, to obtain the second picture description text. The vocabulary includes a plurality of words. When performing sampling on the vocabulary, the terminal determines the sampling parameters of a plurality of words in the vocabulary based on the first picture description text. The sampling parameter indicates a probability that a word is sampled as a word in the second picture description text. The vocabulary is sampled based on the sampling parameters of the plurality of (candidate) words in the vocabulary, to obtain the second picture description text.

In this embodiment of the present disclosure, a picture is generated based on the second picture description text obtained by expansion. To ensure that the picture generated based on the second picture description text conforms to the first picture description text, the second picture description text needs to be semantically associated with the first picture description text. Therefore, the sampling parameter of a word may be determined based on a correlation between the word in the vocabulary and the first picture description text. The higher correlation between the word and the first picture description text indicates a higher probability that the word is sampled as a word in the second picture description text.

In one embodiment, the operation of determining sampling parameters of candidate words in a vocabulary based on the first picture description text by using a picture description text expansion model includes: correlation parameters of the candidate words in the vocabulary is determined, a correlation parameter indicating a semantic correlation degree between a corresponding candidate word and the first picture description text; and the sampling parameter of the word in the vocabulary is determined based on the correlation parameter of the word in the vocabulary.

When determining the sampling parameter of the word in the vocabulary based on the correlation parameter of the word in the vocabulary, the terminal may directly determine the correlation parameter of the word as the sampling parameter of the word, may alternatively perform an operation on the correlation parameter of the word to obtain the sampling parameter of the word, or may determine the sampling parameter of the word based on the correlation parameter and another parameter of the word. Another parameter of the word may be a co-occurrence parameter and the like. This is not limited in this embodiment of the present disclosure. The co-occurrence parameter represents a probability that a plurality of words co-occur in one document or a paragraph of text.

In another embodiment, to ensure that the expanded second picture description text has abundant description objects, causing a generated picture to have enriched content and appealing backgrounds, and compatibility of different included description objects in a same picture, the sampling parameters of corresponding words in the vocabulary may further be increased based on the standard picture description text and the brief picture description text of each reference picture, so that when the first picture description text includes a word in the brief picture description text, the second picture description text expanded by the terminal includes the word in the corresponding standard picture description text. In some embodiments, the operation of determining sampling parameters of candidate words in a vocabulary by using a picture description text expansion model includes: correlation parameters of the candidate words in the vocabulary is determined by using the picture description text expansion model, a correlation parameter indicating a semantic correlation degree between a corresponding candidate word and the first picture description text; and a description word pair is obtained, the description word pair including a first word in brief picture description text and a second word in a corresponding standard picture description text pair; and a sampling parameter of the word in the vocabulary, by using the picture description text expansion model, is determined based on a co-occurrence parameter of the description word pair and the correlation parameter of the word in the vocabulary, the co-occurrence parameter indicating a probability that the corresponding standard picture description text includes the second word in a case that the brief picture description text includes the first word.

In some embodiments, the standard picture description text is obtained by performing word expansion on the brief picture description text. In some embodiments, picture description text inputted by a user is obtained as brief picture description text, and a person skilled in the art performs word expansion on the brief picture description text, to obtain standard picture description text.

In some other embodiments, brief picture description text is obtained by performing keyword extraction on standard picture description text. In some embodiments, description of a picture in a network is obtained as standard picture description text, keyword extraction is performed on the standard picture description text, and an extracted keyword is used as brief picture description text.

When the description of the picture in the network is obtained as the standard picture description text, the picture satisfying a picture quality condition may be selected from the network, and the description of the picture satisfying the picture quality condition is obtained as the standard picture description text, indirectly ensuring the quality of the standard picture description text. Alternatively, a screening condition may alternatively be set for the standard picture description text, and a picture description text satisfying a description quality condition in the network is obtained as the standard picture description text. Certainly, the standard picture description text may be selected manually by a technical person, or may be selected automatically by setting a screening condition (for example, a quantity of words reaches a specified quantity). The quality condition may include a condition of at least one dimension such as a size, a definition, a color, or a style. In addition, a manner of obtaining the brief picture description text and the standard picture description text is not limited in this embodiment of the present disclosure.

The co-occurrence parameter of the description word pair indicates a probability that the corresponding standard picture description text includes the second word in a case that the brief picture description text includes the first word. In some embodiments, a larger value of the co-occurrence parameter indicates a higher probability. Therefore, the co-occurrence parameter of the description word pair may be obtained by performing statistical analysis on the brief picture description text and the standard picture description text. In some embodiments, the method further includes: statistical analysis is performed on words in standard picture description text and words in brief picture description text of each reference picture, to obtain a plurality of description word pairs and a co-occurrence parameter of the plurality of description word pairs.

In some embodiments, the operation of performing statistical analysis on words in standard picture description text and words in brief picture description text of each reference picture, to obtain a plurality of description word pairs and the co-occurrence parameter of the plurality of description word pairs includes: a ratio of a number of times that the second word occurs in the specified standard picture description text to a total quantity of words in the specified standard picture description text is determined as the co-occurrence parameter of the description word pair. The specified standard picture description text corresponds to the brief picture description text including the first word.

For example, the first word is included in brief picture description text 1 and brief picture description text 2. A number of times that the second word occurs in standard picture description text 1 and standard picture description text 2 is determined, and a ratio of the number of times of occurrence to a total quantity of words in the standard picture description text 1 and the standard picture description text 2 is determined as a co-occurrence probability of the description word pair: the first word and the second word. The standard picture description text 1 corresponds to the brief picture description text 1, and the standard picture description text 2 corresponds to the brief picture description text 2.

In addition, if the co-occurrence parameter of a description word pair is relatively small, an impact on a sampling parameter of the word is also relatively small. To reduce computational power, when the sampling parameter of a word in a vocabulary is determined, the description word pair with a relatively small co-occurrence parameter may not be considered. In some embodiments, the method further includes: a plurality of description word pairs are screened based on a co-occurrence parameter threshold, and the description word pair whose co-occurrence parameter is not less than the co-occurrence parameter threshold is reserved. The co-occurrence parameter threshold may be any value. In some embodiments, the co-occurrence parameter threshold is an empirical value, a value set by a technical person, or the like. The co-occurrence parameter threshold is not limited in this embodiment of the present disclosure.

In some embodiments, the operation of determining, by using a picture description text expansion model, sampling parameters of candidate words in a vocabulary based on the co-occurrence parameter of a description word pair and correlation parameters of the candidate words in the vocabulary includes: a sum of the co-occurrence parameter and correlation parameter of the word is determined as the sampling parameter of the word by using the picture description text expansion model; or weighted summation is performed on the co-occurrence parameter and correlation parameter of the word, to obtain the sampling parameter of the word. A value of the sampling parameter may be in positive correlation with a value of the co-occurrence parameter. To be specific, a larger co-occurrence parameter leads to a larger sampling parameter, and a smaller co-occurrence parameter leads to a smaller sampling parameter.

For example, a co-occurrence parameter of a word A in first picture description text and a word B in a vocabulary is expressed as P_adj [A, B], and a correlation parameter of the word A and the word B is expressed as softmax [A, B], so that a sampling parameter of the word B is expressed as softmax [A, B]+a*P_adj [A, B]. Where a is a weight of the co-occurrence parameter. The weight is any value between 0 and 1, for example, the weight is 0.3 or 0.5.

In addition, when the sampling parameter of the word in the vocabulary is determined based on the co-occurrence parameter of the description word pair and the correlation parameter of the word in the vocabulary, to avoid the sampling probability represented by the sampling parameter being greater than 1, after the sampling parameter is determined, normalization processing may be further performed on the determined sampling parameter, to make the sampling probability represented by the sampling parameter not greater than 1.

303: The terminal samples the vocabulary based on the sampling parameters of the candidate words in the vocabulary by using the picture description text expansion model, to obtain second picture description text.

The sampling parameter of the word indicates a probability that the word is sampled as a word in the second picture description text. Therefore, the operation in which the terminal samples the vocabulary based on the sampling parameters of the candidate words in the vocabulary, to obtain second picture description text may include: Based on the sampling parameters of the candidate words in the vocabulary, the terminal uses the word with the largest sampling parameter as a word in the second picture description text.

To ensure the richness of the second picture description text, the quantity of words in the second picture description text may further be set, and the terminal samples a corresponding quantity of words from the vocabulary based on the sampling parameters of the candidate words in the vocabulary by using the picture description text expansion model, to obtain the second picture description text. In one embodiment, the terminal samples a plurality of words at a time to obtain the second picture description text. The operation in which the terminal samples the vocabulary based on the sampling parameters of the candidate words in the vocabulary by using the picture description text expansion model to obtain second picture description text includes: The terminal uses a target quantity of words with the largest sampling parameters as the words in the second picture description text based on the sampling parameters of the candidate words in the vocabulary by using the picture description text expansion model. The target quantity is a quantity of words in the second picture description text.

In another embodiment, the terminal samples one word each time by using the picture description text expansion model, and obtains the second picture description text by means of multiple sampling. The operation in which the terminal samples the vocabulary based on the sampling parameters of the candidate words in the vocabulary by using the picture description text expansion model to obtain second picture description text includes: The terminal uses the words with the largest sampling parameters as the words in the second picture description text based on the sampling parameters of the candidate words in the vocabulary by using the picture description text expansion model; and The terminal re-determines sampling parameters of other words than the sampled words in the vocabulary based on the first picture description text and the sampled words by using the picture description text expansion model, and uses the words with the largest sampling parameters as the words in the second picture description text. The terminal repeatedly performs the operation of re-determining the sampling parameters of other words than the sampled words in the vocabulary based on the first picture description text and the sampled words by using the picture description text expansion model, and using the words with the largest sampling parameters as the words in the second picture description text, until the quantity of words in the second picture description text reaches the target quantity.

In addition, in this embodiment of the present disclosure, the generation of one piece of second picture description text is taken as an example to exemplarily describe a process of generating the second picture description text. In another embodiment, the terminal may generate a plurality of pieces of second picture description text, and generate a corresponding picture for each piece of second picture description text.

Next, this embodiment of the present disclosure exemplarily describes an operation of “performing text expansion on the first picture description text by using the picture description text expansion model, to obtain a plurality of pieces of second picture description text”:

In one embodiment, one sampling condition may be set, causing a plurality of words in the vocabulary to satisfy the sampling condition. During each sampling, a plurality of words satisfying the sampling condition are sampled, and during each sampling, the plurality of sampled words are respectively used as words in different pieces of second picture description text, to obtain a plurality of pieces of different second picture description text. The operation in which the terminal samples the vocabulary based on the sampling parameters of the candidate words in the vocabulary by using a picture description text expansion model, to obtain second picture description text includes: A plurality of words in the vocabulary whose sampling parameters satisfy a sampling condition are sampled by using the picture description text expansion model based on the sampling parameters of the words in the vocabulary, to obtain a plurality of pieces of second picture description text. Different pieces of second picture description text include different words satisfying the sampling condition.

The sampling condition may be that the sampling parameter is not less than a sampling parameter threshold, or may be that the sampling parameter is one of the P largest sampling parameters among the sampling parameters of a plurality of words in the vocabulary. The sampling condition is not limited in this embodiment of the present disclosure.

For example, the terminal may sort the words in the vocabulary according to a descending order of the sampling parameters, and selects some top-ranked words, to realize the sampling on the vocabulary, so as to obtain a second picture based on the sampled words. Selecting some top-ranked words may be to select a preset quantity (such as P) of consecutive words from the first ranked word. To be specific, the terminal may sample P words with the largest sampling parameters from the vocabulary. P is an integer greater than 1.

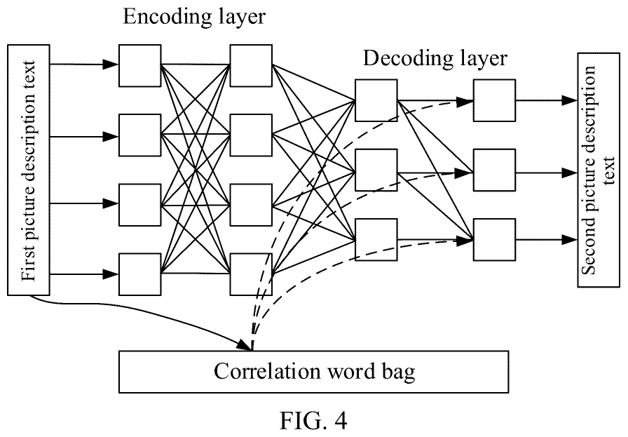

The picture description text expansion model may be any natural language generation model. The picture description text expansion model is not limited in this embodiment of the present disclosure. A model structure shown in FIG. 4 is taken as an example to exemplarily describe the picture description text expansion model. As shown in FIG. 4, the picture description text expansion model includes an encoding layer and a decoding layer. First picture description text is encoded by using the encoding layer, to obtain a feature of the first picture description text. Then the feature of the first picture description text is decoded by using the decoding layer, to obtain at least one second picture description text. During the decoding, a correlation word bag of the picture description text may be referred to. The correlation word bag includes co-occurrence parameters of a plurality of description word pairs.

304: The terminal obtains a plurality of random factors, and generates pictures respectively based on the random factors and the second picture description text for the plurality of random factors.

In this embodiment of the present disclosure, the random factor indicates an initial state of a to-be-generated picture. By obtaining the plurality of random factors, and generating the pictures based on each random factor and the second picture description text, a plurality of different pictures may be obtained, causing the pictures generated based on the second picture description text to have diversity.

The random factor may be any value, such as 1, 2, 10, 50, or 100. The random factor is not limited in this embodiment of the present disclosure. The terminal may randomly select a value as the random factor from a target value interval. The target value interval may be any value interval. The target value interval is not limited in this embodiment of the present disclosure.

In some embodiments, the plurality of random factors may alternatively be preset. A manner of obtaining the random factors is not limited in this embodiment of the present disclosure.

In one embodiment, operation 304 may be performed by using a picture generation model. The picture generation model may be a diffusion model, such as a stable diffusion 1.4 model.

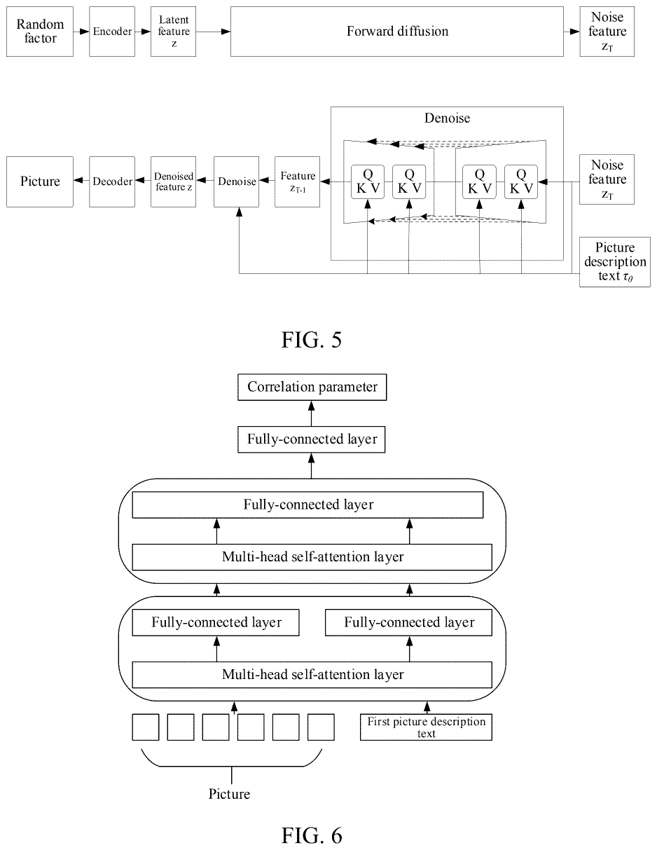

For example, the picture generation model is shown in FIG. 5. A random factor x and a picture description text are inputted into the picture generation model. The picture generation model encodes the random factor into a latent representation space to obtain a latent feature z, and then performs forward diffusion on the latent feature z, to obtain a noise feature zT. The picture generation model processes the picture description text and the noise feature zT by using a cross-attention layer, to obtain a processed noise feature zT-1, so that information of the picture description text is fused into the processed noise feature zT-1. The processed noise feature zT-1 is denoised to obtain a denoised feature z. The denoised feature z is decoded to obtain a picture.

In addition, in this embodiment of the present disclosure, a picture generation process is described exemplarily by taking the generation of a plurality of pictures based on one piece of second picture description text as an example. In another embodiment, a picture may alternatively be generated based on one piece second picture description text, and the picture generation process is not limited in this embodiment of the present disclosure.

305: The terminal sorts the plurality of pictures based on at least one of correlation parameters and quality parameters of the plurality of pictures.

The correlation parameter of the picture represents a correlation degree between the picture and the first picture description text. In this embodiment of the present disclosure, although the picture is generated based on the second picture description text, the generated picture apparently needs to conform to the intention of the first picture description text. Therefore, the terminal sorts the plurality of pictures based on the correlation parameters of the plurality of pictures, so as to rank the pictures that are more correlated to the first picture description text in the top. An example in which the first picture description text is the picture description text inputted by the user is used. A plurality of pictures are sorted based on the correlation parameters of the plurality of pictures, and the pictures better conforming to the intention of the user may be ranked in the top for the user to select.

In addition, a manner for the terminal to determine the correlation parameters of a plurality of pictures is not limited in this embodiment of the present disclosure. In one embodiment, the terminal determines the correlation parameter between the first picture description text and the picture based on a proportion of an object described by the first picture description text in the picture. In another embodiment, the terminal processes the first picture description text and the picture by using a correlation model, to obtain the correlation parameter of the picture.

The correlation model is configured to determine a correlation between two pieces of inputted information. A model structure of the correlation model is not limited in this embodiment of the present disclosure. The correlation model may be trained based on first sample information, second sample information, and the sample correlation. The sample correlation refers to a correlation between the first sample information and the second sample information.

For example, the correlation model is shown in FIG. 6. First, a picture is segmented into 36 (6*6) small blocks, then an embedding (vector embedding) representation of each small block is established by using a fully-connected network, the embedding representation of each small block is inputted to a multi-head self-attention layer for self-attention processing, and a feature obtained after the self-attention processing is inputted to a fully-connected layer for depth feature extraction. Word segmentation is performed on the first picture description text, and a word vector of each word segmentation result is obtained; a plurality of word vectors are inputted to the multi-head self-attention layer for self-attention processing; and the feature obtained after the self-attention processing is inputted to the fully-connected layer for depth feature extraction. Then, a picture feature and a picture description text feature obtained by depth feature extraction are inputted to the multi-head self-attention layer, to obtain a query feature of the picture description text feature, and a key feature and a value feature of the picture feature. A weight of the value feature is determined based on the query feature of the picture description text feature and the key feature. Weighting processing is performed on the value feature based on the weight of the value feature, to obtain a feature obtained after the self-attention processing. The feature is inputted to the fully-connected layer for depth feature extraction, and then correlation prediction is performed to obtain the correlation parameter between the picture and the first picture description text.

Because the picture generation model may introduce a random factor when generating the picture based on the second picture description text, the generated picture exhibits diversity. To avoid poor quality of the generated picture, in this embodiment of the present disclosure, a plurality of pictures may be further sorted based on quality parameters of the plurality of pictures, so as to ensure that the pictures with a relatively high quality rank at the top for user selection.

In addition, a manner for the terminal to determine the quality parameters of the plurality of pictures is not limited in this embodiment of the present disclosure. In one embodiment, the terminal determines the quality parameter of the picture based on at least one of definition, brightness, tone, and the like of the picture. In another embodiment, the terminal processes the picture by using a quality evaluation model, to obtain the quality parameter of the picture.

The quality evaluation model is configured to evaluate the picture quality. A model structure of the quality evaluation model is not limited in this embodiment of the present disclosure. The quality evaluation model may be obtained by training based on a sample picture and a sample quality parameter, and the sample quality parameter is a quality parameter of the sample picture.

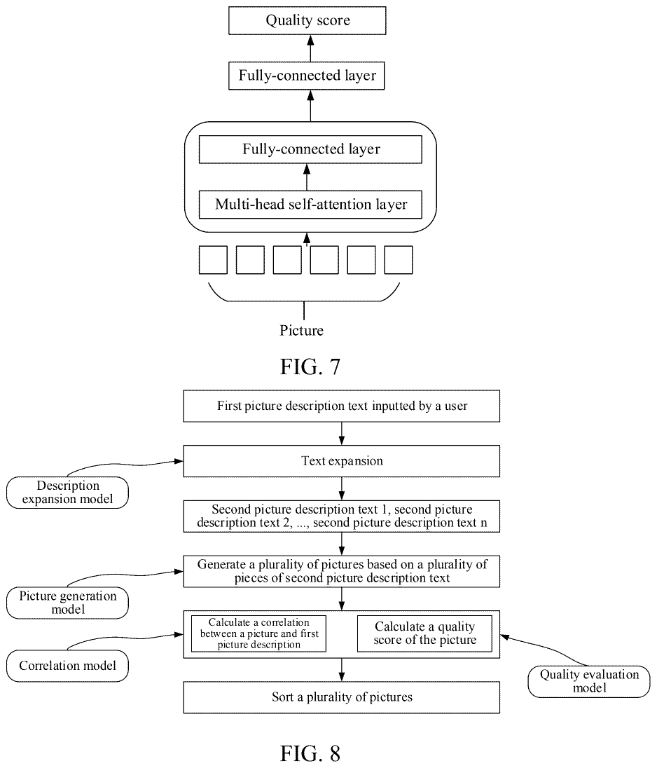

In this embodiment of the present disclosure, a quality evaluation model shown in FIG. 7 is used as an example to exemplarily describe a process of processing a picture by using the quality evaluation model. As shown in FIG. 7, first, a picture is segmented into 36 (6*6) small blocks, then an embedding representation of each small block is established by using a fully-connected network, the embedding representation of each small block is inputted into a multi-head self-attention layer for self-attention processing, then a feature obtained after the self-attention processing is inputted into a fully-connected layer for depth feature extraction, and then an obtained feature is inputted into a quality evaluation layer, to obtain a quality score.

In some embodiments, the operation in which the terminal sorts a plurality of pictures based on at least one of correlation parameters and quality parameters of the plurality of pictures includes: The terminal determines comprehensive evaluation parameters of the plurality of pictures based on the correlation parameters and quality parameters of the plurality of pictures; and the plurality of pictures are sorted based on the comprehensive evaluation parameters of the plurality of pictures.

In some embodiments, the operation in which the terminal determines comprehensive evaluation parameters of the plurality of pictures based on the correlation parameters and quality parameters of the plurality of pictures includes: The terminal determines a sum of the correlation parameter and the quality parameter of the picture as the comprehensive evaluation parameter of the picture; or The terminal performs weighted summation on the correlation parameter and quality parameter of the picture, to obtain the comprehensive evaluation parameter of the picture. Weights of the correlation parameter and quality parameter may be the same or different. This is not limited in this embodiment of the present disclosure. In some embodiments, a weight of the correlation parameter is 0.7, and a weight of the quality parameter is 0.3.

306: The terminal displays at least one picture based on an arrangement order of the plurality of pictures.

After determining the arrangement order of the plurality of pictures, the terminal selects one or more pictures for display based on the arrangement order of the plurality of pictures, and allows a user to make a selection.

In some embodiments, the terminal displays all the generated pictures. In some embodiments, the operation in which the terminal displays at least one picture based on an arrangement order of the plurality of pictures includes: the plurality of pictures are arranged and displayed according to the arrangement order of the plurality of pictures.

In some embodiments, the terminal only displays one picture. In some embodiments, the operation in which the terminal displays at least one picture based on an arrangement order of the plurality of pictures includes: the picture ranking the first is displayed.

In some embodiments, the terminal displays a certain quantity of pictures. In some embodiments, the operation in which the terminal displays at least one picture based on an arrangement order of the plurality of pictures includes: a plurality of pictures ranking at top target positions are displayed based on the arrangement order of the plurality of pictures. The target position may be any position. The target position is not limited in the embodiments of the present disclosure.

In addition, operation 305 and operation 306 are example solutions. To be specific, operation 305 and operation 306 may be performed or not performed. Whether to perform operation 305 and operation 306 may be determined according to an actual application requirement.

This embodiment of the present disclosure provides a text-based picture generation solution. First, text expansion is performed on the first picture description text by using the picture description text expansion model, to obtain the second picture description text, and then the picture is generated by using the second picture description text. Because the picture description text expansion model is obtained by training based on the standard picture description text and the brief picture description text of each reference picture, the standard picture description text includes a plurality of words describing a primary description object of the reference picture and at least one word that describes a secondary description object of the target picture, and the brief picture description text is a keyword for describing the primary description object in the standard picture description text, the picture description text expansion model may expand the keyword describing the primary description object into other words describing the primary description object, and may further expand the keyword into words describing the secondary description object. Therefore, the content of the expanded picture description text is rich, the content of the picture generated based on the expanded picture description text is rich, and accordingly the picture generation quality is improved.

Furthermore, in this embodiment of the present disclosure, when the vocabulary is sampled to obtain the second picture description text, a co-occurrence parameter of a description word pair is introduced. A word having a relatively high correlation degree may be sampled, and a word having a relatively high co-occurrence probability may alternatively be sampled, so that the sampled words are richer, and content of the generated second picture description text is also richer, and accordingly, the quality of a picture generated based on the second picture description text is also higher.

Furthermore, in the embodiments of the present disclosure, a plurality of pictures may be generated, and the plurality of pictures are sorted based on the correlation between the picture and the first picture description text and the picture quality, so as to rank the pictures correlated to the first picture description text and having high quality in the top, thereby improving the picture selection experience of a user.

In this embodiment of the present disclosure, FIG. 8 is used as an example to exemplarily describe a text-based picture generation process. As shown in FIG. 8, first, first picture description text inputted by a user is obtained, and text expansion is performed on the first picture description text by using a picture description text expansion model, to obtain a plurality of pieces of second picture description text. The plurality of pieces of second picture description text are inputted separately into a picture generation model, and at least one picture is generated for each piece of second picture description text by using the picture generation model; and then, each picture is input into a correlation model and a quality evaluation model, to determine a correlation parameter and a quality parameter of each picture. The plurality of pictures are sorted based on the correlation parameter and the quality parameter of each picture.

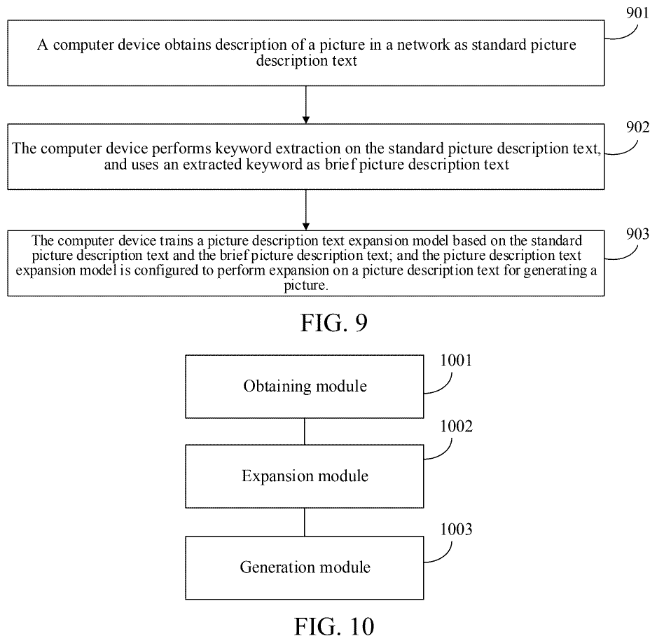

FIG. 9 is a flowchart of a training method for a picture description text expansion model used in picture generation according to an embodiment of the present disclosure. In this embodiment of the present disclosure, using a computer device as an execution body is taken as an example for exemplary description. Referring to FIG. 9, the method includes:

901: A computer device obtains description of a picture in a network as standard picture description text.

The picture in the network may be any picture disseminated on the Internet. For example, the picture is from a video website, or may be from any existing database. The picture in the network is not limited in this embodiment of the present disclosure. In addition, most of pictures disseminated on the Internet are provided with picture tags. The picture tags are configured for describing the pictures, and may be regarded as descriptions of the pictures. The picture obtained by the computer device from the network may be a reference picture in the embodiment shown in FIG. 3.

In some embodiments, the computer device randomly obtains a picture from the network, and uses the description of the picture as standard picture description text. In some embodiments, the computer device obtains a picture satisfying a picture quality condition from the network, and uses the description of the picture as the standard picture description text. In some embodiments, the computer device obtains a picture whose description exceeds a target quantity of words from the network, and uses the description of the picture as the standard picture description text. A manner of obtaining the standard picture description text is not limited in this embodiment of the present disclosure.

902: The computer device performs keyword extraction on the standard picture description text, and uses an extracted keyword as brief picture description text.

The computer device may perform keyword extraction on the standard picture description text in any keyword extraction manner. The keyword extraction manner is not limited in this embodiment of the present disclosure, and the following embodiment is used as an example to describe the keyword extraction process.

In some embodiments, the computer device performs word segmentation on the standard picture description text, determines a semantic weight of each word segmentation result in the standard picture description text based on semantics of each word segmentation result and semantics of the standard picture description text, and uses the word segmentation result with the highest semantic weight as the brief picture description text.

In addition, to ensure the accuracy of the standard picture description text and the brief picture description text, the obtained standard picture description text and brief picture description text may further be manually verified or screened.

903: The computer device trains a picture description text expansion model based on the standard picture description text and the brief picture description text. The picture description text expansion model is configured to perform expansion on picture description text for generating a picture.

The computer device may input the brief picture description text into the picture description text expansion model, and the picture description text expansion model performs word expansion on the brief picture description text according to the method shown in operation 302 to operation 303, to obtain a predicted picture description text. The picture description text expansion model is trained based on a difference between the predicted picture description text and the standard picture description text, so as to converge an error of the picture description text expansion model.

In addition, this embodiment of the present disclosure may be implemented by using at least one of the picture description text expansion model, the picture generation model, the correlation model, and the quality evaluation model. Therefore, the at least one model may be trained together. For example, a picture is obtained from a network as a sample picture, description of the picture is used as standard picture description text, keyword extraction is performed the standard picture description text, an extracted keyword is used as brief picture description text, and a correlation parameter and a quality parameter are annotated for the sample picture.

When the model is trained, correspondences between some sample pictures and the standard picture description text, the correlation parameter, and the quality parameter may be disarranged, to form negative samples, thereby improving a training effect of the model.

According to the training method for a picture description text expansion model used in picture generation provided in the embodiments of the present disclosure, the standard picture description text may be automatically obtained from the network, and the brief picture description text may be automatically generated based on the standard picture description text, thereby reducing the difficulty in obtaining a sample set, and also reducing the labor cost and material cost. The picture description text expansion model trained by using the training method for the picture description text expansion model in this embodiment may be used in the text-based picture generation method in any of the foregoing embodiments.

FIG. 10 is a schematic structural diagram of a text-based picture generation apparatus according to an embodiment of the present disclosure. Referring to FIG. 10, the apparatus includes:
an obtaining module 1001, configured to obtain first picture description text, the first picture description text describing picture content of a picture to be generated;
an expansion module 1002, configured to process the first picture description text by using a picture description text expansion model, to obtain second picture description text, the picture description text expansion model being trained based on sample standard picture description texts and sample brief picture description texts of reference pictures, and being configured for expanding the brief picture description text into the corresponding standard picture description text, the standard picture description text including a plurality of words that describe a primary description object of a target picture and at least one word that describes a secondary description object of the target picture, and the brief picture description text being a keyword for describing the primary description object in the standard picture description text; and
a generation module 1003, configured to generate a picture based on the second picture description text.

This embodiment of the present disclosure provides a text-based picture generation solution. First, text expansion is performed on the first picture description text by using the picture description text expansion model, to obtain the second picture description text, and then the picture is generated by using the second picture description text. Because the picture description text expansion model is obtained by training based on the standard picture description text and the brief picture description text of each reference picture, the standard picture description text includes a plurality of words describing a primary description object of the reference picture and at least one word that describes a secondary description object of the target picture, and the brief picture description text is a keyword for describing the primary description object in the standard picture description text, the picture description text expansion model may expand the keyword describing the primary description object into other words describing the primary description object, and may further expand the keyword into words describing the secondary description object. Therefore, the content of the expanded picture description text is rich, the content of the picture generated based on the expanded picture description text is rich, and accordingly the picture generation quality is improved.

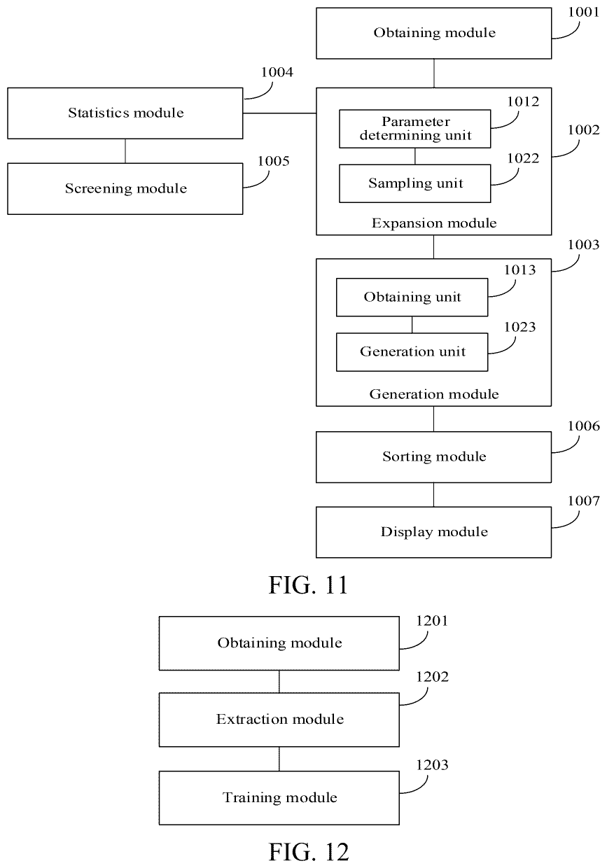

As shown in FIG. 11, in some embodiments, an expansion module 1002 includes:
a parameter determining unit 1012, configured to determine sampling parameters of candidate words in a vocabulary by using the picture description text expansion model, a sampling parameter indicating a probability that a corresponding candidate word is sampled as a word in the second picture description text; and
a sampling unit 1022, configured to sample the vocabulary based on the sampling parameters of the candidate words in the vocabulary by using the picture description text expansion model, to obtain second picture description text.

In some embodiments, the parameter determining unit 1012 is configured to determine a correlation parameter of a word in the vocabulary by using the picture description text expansion model, a correlation parameter indicating a semantic correlation degree between a corresponding candidate word and the first picture description text; obtain a description word pair, the description word pair including a first word in brief picture description text and second word in a corresponding standard picture description text pair; and determine the sampling parameter of the word in the vocabulary based on a co-occurrence parameter of the description word pair and the correlation parameter of the word in the vocabulary by using the picture description text expansion model, the co-occurrence parameter indicating a probability that the corresponding standard picture description text includes the second word in a case that the brief picture description text includes the first word.

In some embodiments, the apparatus further includes:
a statistics module 1004, configured to perform statistical analysis on words in the standard picture description text and words in the brief picture description text of each reference picture, to obtain a plurality of description word pairs and co-occurrence parameters of the plurality of description word pairs.

In some embodiments, the apparatus further includes:
a screening module 1005, configured to screen a plurality of description word pairs based on a co-occurrence parameter threshold, and reserve the description word pair whose co-occurrence parameter is not less than the co-occurrence parameter threshold.

In some embodiments, the sampling unit 1022 is configured to sample a plurality of words in the vocabulary whose sampling parameters satisfy a sampling condition based on the sampling parameter of each word in the vocabulary by using the picture description text expansion model, to obtain a plurality of pieces of second picture description text, and different pieces of second picture description text include different words satisfying the sampling condition; and

The generation module 1003 is configured to perform an operation of generating a picture based on each piece of second picture description text respectively for the plurality of pieces of second picture description text.

In some embodiments, the expansion module 1002 is configured to perform word expansion on the first picture description text by using the picture description text expansion model, to obtain second picture description text, and the picture description text expansion model is configured to expand at least one word that is semantically associated with the inputted picture description text.

In some embodiments, the generation module 1003 includes:
an obtaining unit 1013, configured to obtain a plurality of random factors, the random factor indicating an initial state of a to-be-generated picture; and
a generation unit 1023, configured to generate pictures based on the random factors and the second picture description text respectively for the plurality of random factors.

In some embodiments, there are a plurality of pictures; The apparatus further includes:
a sorting module 1006, configured to sort a plurality of pictures based on at least one of correlation parameters and quality parameters of the plurality of pictures; and
a display module 1007, configured to display at least one picture based on an arrangement order of the plurality of pictures.

In some embodiments, the display module 1007 is configured to arrange and display the plurality of pictures according to the arrangement order of the plurality of pictures; or

the display module 1007 is configured to display a picture ranking the first; or

the display module 1007 is configured to display a plurality of pictures ranking at top target positions based on the arrangement order of the plurality of pictures.

Moreover, the text-based picture generation apparatus provided in the foregoing embodiments are illustrated only with an example of division of the foregoing function modules. In practical applications, the foregoing functions may be allocated to and completed by different function modules according to requirements. That is, the internal structure of the terminal is divided into different function modules to complete all or some of the functions described above. In addition, the text-based picture generation apparatus provided in the foregoing embodiments and the text-based picture generation method embodiments belong to a same concept. For details of a specific implementation process, refer to the method embodiments. Details are not described herein again.

FIG. 12 is a schematic structural diagram of a training apparatus for a picture description text expansion model used in picture generation according to an embodiment of the present disclosure. Referring to FIG. 12, the apparatus includes:
an obtaining module 1201, configured to obtain description of a picture in a network as standard picture description text;
an extraction module 1202, configured to perform keyword extraction on the standard picture description text, and use an extracted keyword as brief picture description text; and
a training module 1203, configured to train a picture description text expansion model based on standard picture description text and brief picture description text, the picture description text expansion model being configured to expand the picture description text configured for generating a picture.

According to the training solution for a picture description text expansion model used in picture generation provided in this embodiment of the present disclosure, the standard picture description text may be automatically obtained from the network, and the brief picture description text may be automatically generated based on the standard picture description text, thereby reducing the difficulty in obtaining a sample set, and also reducing the labor cost and material cost.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

In some embodiments, a computer device is provided as a terminal. The terminal includes a processor and a memory, the memory has at least one computer-readable instruction stored therein, the at least one computer-readable instruction is loaded and executed by the processor to implement the operations of the text-based picture generation method, or the operations of the training method for a picture description text expansion model used in picture generation described in the above embodiments.

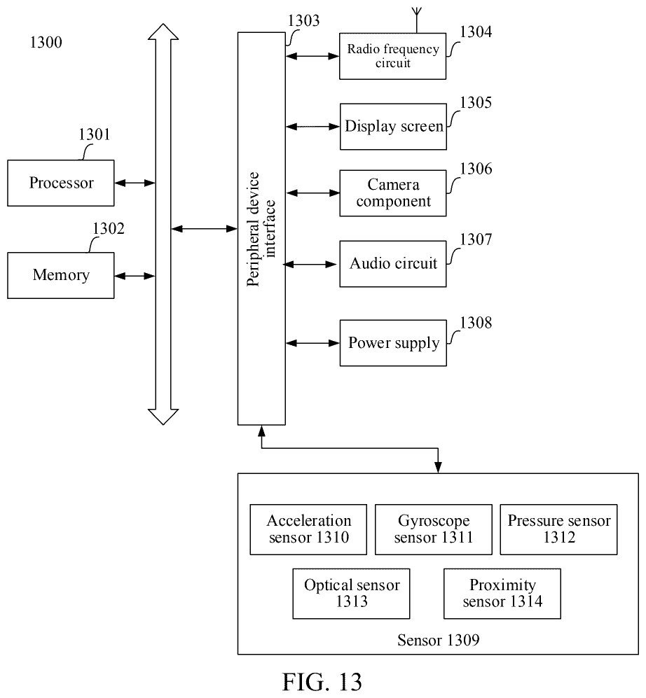

FIG. 13 is a schematic structural diagram of a structure of a terminal 1300 according to an exemplary embodiment of the present disclosure.

The terminal 1300 includes a processor 1301 and a memory 1302.

The processor 1301 may include one or more processing cores, for example, a 4-core processor or an 8-core processor. The processor 1301 may be implemented in at least one hardware form of a digital signal processor (DSP), a field-programmable gate array (FPGA), and a programmable logic array (PLA). The processor 1301 may alternatively include a main processor and a co-processor. The main processor is a processor configured to process data in an awake state, and is also referred to as a central processing unit (CPU). The co-processor is a low power consumption processor configured to process the data in a standby state. In some embodiments, the processor 1301 may be integrated with a graphics processing unit (GPU). The GPU is configured to render and draw content that needs to be displayed on a display screen. In some embodiments, the processor 1301 may further include an artificial intelligence (AI) processor. The AI processor is configured to process computing operations related to machine learning.

The memory 1302 may include one or more computer-readable storage media. The computer-readable storage medium may be non-transient. The memory 1302 may further include a high-speed random access memory and a nonvolatile memory, for example, one or more disk storage devices or flash storage devices. In some embodiments, the non-transient computer-readable storage medium in the memory 1302 is configured to store at least one computer-readable instruction. The at least one computer-readable instruction is configured to be executed by the processor 1301 to implement the text-based picture generation method or the training method for a picture description text expansion model used in picture generation provided in the method embodiments of the present disclosure.

In some embodiments, the terminal 1300 may alternatively include: a peripheral device interface 1303 and at least one peripheral device. The processor 1301, the memory 1302, and the peripheral device interface 1303 may be connected through a bus or a signal cable. Each peripheral device may be connected to the peripheral device interface 1303 through a bus, a signal cable, or a circuit board. In some embodiments, the peripheral device includes: at least one of a radio frequency (RF) circuit 1304, a display screen 1305, a camera component 1306, an audio circuit 1307, and a power supply 1308.

The peripheral device interface 1303 may be configured to connect the at least one peripheral device related to input/output (I/O) to the processor 1301 and the memory 1302. In some embodiments, the processor 1301, the memory 1302, and the peripheral device interface 1303 are integrated on a same chip or circuit board. In some other embodiments, any one or two of the processor 1301, the memory 1302, and the peripheral device interface 1303 may be implemented on an independent chip or circuit board. This is not limited in this embodiment.

The RF circuit 1304 is configured to receive and transmit an RF signal, also referred to as an electromagnetic signal. The RF circuit 1304 communicates with a communication network and other communication devices through the electromagnetic signal. The RF circuit 1304 converts an electric signal into an electromagnetic signal for transmission, or converts a received electromagnetic signal into an electric signal. In some embodiments, the RF circuit 1304 includes: an antenna system, an RF transceiver, one or more amplifiers, a tuner, an oscillator, a digital signal processor, a codec chip set, a subscriber identity module card, and the like. The radio frequency circuit 1304 may communicate with another device through at least one wireless communication protocol. The wireless communication protocol includes, but is not limited to: a metropolitan area network, various generations of mobile communication networks (2G, 3G, 4G, and 5G), a wireless local area network, and/or a wireless fidelity (Wi-Fi) network. In some embodiments, the RF 1304 may further include a circuit related to NFC, and this is not limited in the present disclosure.

The display screen 1305 is configured to display a user interface (UI). The UI may include a graph, text, an icon, a video, and any combination thereof. When the display screen 1305 is a touch display screen, the display screen 1305 further has a capability of acquiring a touch signal on or above a surface of the display screen 1305. The touch signal may be inputted to the processor 1301 as a control signal for processing. In this case, the display screen 1305 may alternatively be configured to provide a virtual button and/or a virtual keyboard that are/is also referred to as a soft button and/or a soft keyboard. In some embodiments, one display 1305 may be arranged on a front panel of the terminal 1300. In some other embodiments, there may be at least two display screens 1305 disposed on different surfaces of the terminal 1300 respectively or in a folded design. In some other embodiments, the display screen 1305 may be a flexible display screen arranged on a curved surface or a folded surface of the terminal 1300. Even, the display screen 1305 may be further set in a non-rectangular irregular pattern, namely, a special-shaped screen. The display screen 1305 may be prepared by using materials such as a liquid crystal display (LCD) or an organic light-emitting diode (OLED).

A camera component 1306 is configured to capture images or videos. In some embodiments, the camera component 1306 includes a front-facing camera and a rear-facing camera. The front-facing camera is disposed on a front panel of the terminal 1300, and the rear-facing camera is disposed on a rear surface of the terminal 1300. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 1306 may further include a flash. The flash may be a monochrome temperature flash, or may be a double color temperature flash. The double color temperature flash refers to a combination of a warm light flash and a cold light flash, and may be configured for light compensation under different color temperatures.

An audio circuit 1307 may include a microphone and a speaker. The microphone is configured to acquire sound waves of a user and an environment, and convert the sound waves into an electrical signal to input to the processor 1301 for processing, or input to the radio frequency circuit 1304 for implementing voice communication. For a purpose of stereo acquisition or noise reduction, there may be a plurality of microphones, respectively disposed at different portions of the terminal 1300. The microphone may further be an array microphone or an omni-directional acquisition type microphone. The speaker is configured to convert electric signals from the processor 1301 or the RF circuit 1304 into sound waves. The speaker may be a film speaker, or may be a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some embodiments, the audio circuit 1307 may further include an earphone jack.

A power supply 1308 is configured to supply power to components in the terminal 1300. The power supply 1308 may be an alternating current, a direct current, a primary battery, or a rechargeable battery. When the power supply 1308 includes a rechargeable battery, the rechargeable battery may support wired charging or wireless charging. The rechargeable battery may be further configured to support a fast charging technology.

In some embodiments, the terminal 1300 further includes one or more sensors 1309. The one or more sensors 1309 include, but are not limited to: an acceleration sensor 1310, a gyroscope sensor 1311, a pressure sensor 1312, an optical sensor 1313, and a proximity sensor 1314.

The acceleration sensor 1310 may detect a magnitude of acceleration on three coordinate axes of a coordinate system established with the terminal 1300. For example, the acceleration sensor 1310 may be configured to detect components of gravity acceleration on the three coordinate axes. The processor 1301 may control, according to a gravity acceleration signal acquired by the acceleration sensor 1310, the touch display screen 1305 to display the UI in a landscape view or a portrait view. The acceleration sensor 1310 may be further configured to acquire motion data of a game or a user.

The gyroscope sensor 1311 may detect a body direction and a rotation angle of the terminal 1300. The gyroscope sensor 1311 may cooperate with the acceleration sensor 1310 to acquire a 3D action by the user on the terminal 1300. The processor 1301 may implement the following functions according to the data acquired by the gyroscope sensor 1311: motion sensing (such as changing the UI according to a tilt operation of the user), image stabilization at shooting, game control, and inertial navigation.

The pressure sensor 1312 may be disposed at a side frame of the terminal 1300 and/or a lower layer of the display screen 1305. When the pressure sensor 1312 is disposed at the side frame of the terminal 1300, a holding signal of the user on the terminal 1300 may be detected. The processor 1301 performs left and right hand recognition or a quick operation according to the holding signal acquired by the pressure sensor 1312. When the pressure sensor 1312 is disposed at the low layer of the display screen 1305, the processor 1301 controls an operable control on the UI according to a pressure operation of the user on the display screen 1305. The operable control includes at least one of a button control, a scroll-bar control, an icon control, and a menu control.

The optical sensor 1313 is configured to acquire ambient light intensity. In an embodiment, the processor 1301 may control the display brightness of the display screen 1305 according to the ambient light intensity acquired by the optical sensor 1313. In some embodiments, when the ambient light intensity is relatively high, the display brightness of the display screen 1305 is increased; and when the ambient light intensity is relatively low, the display brightness of the display screen 1305 is decreased. In another embodiment, the processor 1301 may further dynamically adjust a camera parameter of the camera component 1306 according to the ambient light intensity acquired by the optical sensor 1313.

The proximity sensor 1314, also referred to as a distance sensor, is disposed on the front panel of the terminal 1300. The proximity sensor 1314 is configured to acquire a distance between the user and the front surface of the terminal 1300. In an embodiment, when the proximity sensor 1314 detects that the distance between the user and the front surface of the terminal 1300 gradually decreases, the display screen 1305 is controlled by the processor 1301 to switch from a screen-on state to a screen-off state. When the proximity sensor 1314 detects that the distance between the user and the front surface of the terminal 1300 gradually increases, the display screen 1301 is controlled by the processor 1305 to switch from the screen-off state to the screen-on state.

A person skilled in the art may understand that the structure shown in FIG. 13 constitutes no limitation to the terminal 1300, and the terminal may include more or fewer components than those shown in the figure, or some components may be combined, or a different component deployment may be used.

In some embodiments, the computer device is provided as a server. The server includes a processor and a memory. The memory has at least one computer-readable instruction stored therein. The at least one computer-readable instruction is loaded and executed by the processor to implement the operations of the text-based picture generation method, or the operations of the training method for a picture description text expansion model used in picture generation in the above embodiments.

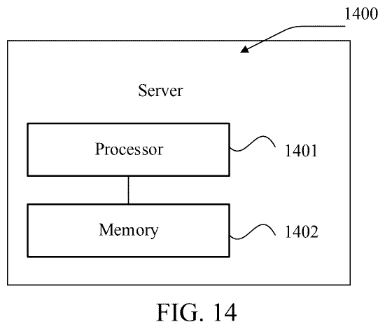

FIG. 14 is a schematic structural diagram of a server according to an embodiment of the present disclosure. A server 1400 may vary considerably depending on configuration or performance, and may include one or more central processing units (CPUs) 1401 and one or more memories 1402. Each memory 1402 has at least one program code stored therein. The at least one program code is loaded and executed by the CPU 1401, to implement the methods provided in the above method embodiments. Certainly, the server may further have components such as a wired or wireless network interface, a keyboard, and an I/O interface for input and output. The server may further include another component for achieving a device function. Details are not described herein.

The server 1400 is configured to perform operations performed by the server in the method embodiments.

An embodiment of the present disclosure further provides a computer-readable storage medium. The computer-readable storage medium has at least one computer-readable instruction stored therein. The at least one computer-readable instruction is loaded and executed by a processor to implement operations of the text-based picture generation method in the above embodiments, or implement operations of the training method for a picture description text expansion model used in picture generation in the above embodiments.

An embodiment of the present disclosure further provides a computer program product, including a computer-readable instruction. The computer-readable instruction is loaded and executed by a processor to implement operations of the text-based picture generation method in the above embodiments, or implement operations of the training method for a picture description text expansion model used in picture generation in the above embodiments.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of the present disclosure, which are described specifically and in detail, but cannot be construed as a limitation to the patent scope of the present disclosure. For a person of ordinary skill in the art, several transformations and improvements can be made without departing from the idea of the present disclosure. These transformations and improvements belong to the protection scope of the present disclosure. Therefore, the protection scope of the patent of the present disclosure shall be subject to the appended claims.

What is claimed is:

1. A text-based picture generation method, comprising:
obtaining first picture description text, the first picture description text describing picture content of a picture to be generated;
performing text expansion on the first picture description text by using a picture description text expansion model, to obtain a second picture description text, the picture description text expansion model being trained based on sample standard picture description texts and sample brief picture description texts of reference pictures and configured to expand a brief picture description text into a corresponding standard picture description text, the standard picture description text comprising a plurality of words that describe a primary description object of a target picture and at least one word that describes a secondary description object of the target picture, and the brief picture description text being a keyword that describes the primary description object in the standard picture description text; and
generating a picture based on the second picture description text.

2. The method according to claim 1, wherein the performing text expansion on the first picture description text by using the picture description text expansion model, to obtain the second picture description text comprises:
determining sampling parameters of candidate words in a vocabulary by using the picture description text expansion model, a sampling parameter indicating a probability that a corresponding candidate word is sampled as a word in the second picture description text; and
sampling the vocabulary based on the sampling parameters of the candidate words in the vocabulary by using the picture description text expansion model, to obtain the second picture description text.

3. The method according to claim 2, wherein the determining sampling parameters of candidate words in a vocabulary by using the picture description text expansion model comprises:
determining correlation parameters of the candidate words in the vocabulary by using the picture description text expansion model, a correlation parameter indicating a semantic correlation degree between a corresponding candidate word and the first picture description text; and
obtaining a description word pair, the description word pair comprising a first word in the brief picture description text and a second word in a corresponding standard picture description text pair; and
determining the sampling parameter of the candidate word in the vocabulary based on a co-occurrence parameter of the description word pair and the correlation parameter of the candidate word in the vocabulary by using the picture description text expansion model, the co-occurrence parameter indicating a probability that the standard picture description text comprises the second word in a case that the brief picture description text comprises the first word.

4. The method according to claim 3, further comprising:
performing statistical analysis on words in the standard picture description text and words in the brief picture description text of each reference picture, to obtain a plurality of description word pairs and the co-occurrence parameter of the plurality of description word pairs.

5. The method according to claim 4, further comprising:
screening the plurality of description word pairs based on a co-occurrence parameter threshold, and reserving the description word pair whose co-occurrence parameter is not less than the co-occurrence parameter threshold.

6. The method according to claim 2, wherein the sampling the vocabulary based on the sampling parameters of the candidate words in the vocabulary by using the picture description text expansion model, to obtain the second picture description text comprises:
sampling a plurality of words in the vocabulary whose sampling parameters satisfy a sampling condition based on the sampling parameters of the candidate words in the vocabulary by using the picture description text expansion model, to obtain a plurality of pieces of second picture description text, different pieces of second picture description text comprising different words satisfying the sampling condition; and
the method further comprises:
performing operations of generating pictures based on the second picture description text respectively for the plurality of pieces of second picture description text.

7. The method according to claim 1, wherein the generating a picture based on the second picture description text comprises:
obtaining a plurality of random factors, the random factor indicating an initial state of a to-be-generated picture; and
generating pictures based on the random factors and the second picture description text respectively for the plurality of random factors.

8. The method according to claim 1, wherein there are a plurality of pictures; the method further comprises:
sorting the plurality of pictures based on at least one of correlation parameters and quality parameters of the plurality of pictures, the correlation parameter of the picture indicating a correlation degree between the picture and the first picture description text; and
displaying at least one picture based on an arrangement order of the plurality of pictures.

9. The method according to claim 8, wherein the displaying at least one picture based on an arrangement order of the plurality of pictures comprises:
arranging and displaying the plurality of pictures according to the arrangement order of the plurality of pictures; or
displaying the picture ranking the first; or
displaying a plurality of pictures ranking at top target positions based on the arrangement order of the plurality of pictures.

10. The method according to claim 1, wherein the picture description text expansion model is trained by:
for each of the reference pictures, obtaining description of the reference picture in a network as the corresponding sample standard picture description text;
performing keyword extraction on the sample standard picture description text, and using an extracted keyword as the sample brief picture description text; and
training the picture description text expansion model based on the sample standard picture description texts and the sample brief picture description texts.

11. A text-based picture generation apparatus, comprising:
a processor and a memory, the memory having at least one computer-readable instruction stored therein, and the at least one computer-readable instruction being loaded and executed by the processor to implement:
obtaining first picture description text, the first picture description text describing picture content of a picture to be generated;
performing text expansion on the first picture description text by using a picture description text expansion model, to obtain a second picture description text, the picture description text expansion model being trained based on sample standard picture description texts and sample brief picture description texts of reference pictures and configured to expand a brief picture description text into a corresponding standard picture description text, the standard picture description text comprising a plurality of words that describe a primary description object of a target picture and at least one word that describes a secondary description object of the target picture, and the brief picture description text being a keyword that describes the primary description object in the standard picture description text; and
generating a picture based on the second picture description text.

12. The apparatus according to claim 11, wherein the performing text expansion on the first picture description text by using the picture description text expansion model, to obtain the second picture description text comprises:
determining sampling parameters of candidate words in a vocabulary by using the picture description text expansion model, a sampling parameter indicating a probability that a corresponding candidate word is sampled as a word in the second picture description text; and
sampling the vocabulary based on the sampling parameters of the candidate words in the vocabulary by using the picture description text expansion model, to obtain the second picture description text.

13. The apparatus according to claim 12, wherein the determining sampling parameters of candidate words in a vocabulary by using the picture description text expansion model comprises:
determining correlation parameters of the candidate words in the vocabulary by using the picture description text expansion model, a correlation parameter indicating a semantic correlation degree between a corresponding candidate word and the first picture description text; and
obtaining a description word pair, the description word pair comprising a first word in the brief picture description text and a second word in a corresponding standard picture description text pair; and
determining the sampling parameter of the candidate word in the vocabulary based on a co-occurrence parameter of the description word pair and the correlation parameter of the candidate word in the vocabulary by using the picture description text expansion model, the co-occurrence parameter indicating a probability that the standard picture description text comprises the second word in a case that the brief picture description text comprises the first word.

14. The apparatus according to claim 13, wherein the processor is further configured to implement:
performing statistical analysis on words in the standard picture description text and words in the brief picture description text of each reference picture, to obtain a plurality of description word pairs and the co-occurrence parameter of the plurality of description word pairs.

15. The apparatus according to claim 14, wherein the processor is further configured to implement:
screening the plurality of description word pairs based on a co-occurrence parameter threshold, and reserving the description word pair whose co-occurrence parameter is not less than the co-occurrence parameter threshold.

16. The apparatus according to claim 12, wherein the sampling the vocabulary based on the sampling parameters of the candidate words in the vocabulary by using the picture description text expansion model, to obtain the second picture description text comprises:
sampling a plurality of words in the vocabulary whose sampling parameters satisfy a sampling condition based on the sampling parameters of the candidate words in the vocabulary by using the picture description text expansion model, to obtain a plurality of pieces of second picture description text, different pieces of second picture description text comprising different words satisfying the sampling condition; and
the processor is further configured to implement:
performing operations of generating pictures based on the second picture description text respectively for the plurality of pieces of second picture description text.

17. The apparatus according to claim 11, wherein the generating a picture based on the second picture description text comprises:
obtaining a plurality of random factors, the random factor indicating an initial state of a to-be-generated picture; and
generating pictures based on the random factors and the second picture description text respectively for the plurality of random factors.

18. The apparatus according to claim 11, wherein there are a plurality of pictures; the processor is further configured to implement:
sorting the plurality of pictures based on at least one of correlation parameters and quality parameters of the plurality of pictures, the correlation parameter of the picture indicating a correlation degree between the picture and the first picture description text; and
displaying at least one picture based on an arrangement order of the plurality of pictures.

19. The apparatus according to claim 18, wherein the displaying at least one picture based on an arrangement order of the plurality of pictures comprises:
arranging and displaying the plurality of pictures according to the arrangement order of the plurality of pictures; or
displaying the picture ranking the first; or
displaying a plurality of pictures ranking at top target positions based on the arrangement order of the plurality of pictures.

20. A non-transitory computer-readable storage medium, the computer-readable storage medium having at least one computer-readable instruction stored therein, and the at least one computer-readable instruction being loaded and executed by a processor to implement:
obtaining first picture description text, the first picture description text describing picture content of a picture to be generated;
performing text expansion on the first picture description text by using a picture description text expansion model, to obtain a second picture description text, the picture description text expansion model being trained based on sample standard picture description texts and sample brief picture description texts of reference pictures and configured to expand a brief picture description text into a corresponding standard picture description text, the standard picture description text comprising a plurality of words that describe a primary description object of a target picture and at least one word that describes a secondary description object of the target picture, and the brief picture description text being a keyword that describes the primary description object in the standard picture description text; and
generating a picture based on the second picture description text.
